(19) United States
(12) Patent Application Publication
(10) Pub. No.: US 2022/0054345 A1
(43) Pub. Date: Feb. 24, 2022

(54) Method apparatus systems and mechanisms for boosting and stimulation of weaker body parts powered by harvested energy from other parts of the body

(71) Applicant: Phil F. Kongtcheu, Cambridge, MA (US)

(72) Inventor: Phil F. Kongtcheu, Cambridge, MA (US)

(73) Assignee: Phil Kongtcheu, Cambridge, MA (US)

(21) Appl. No.: 16/996,760

(22) Filed: Aug. 18, 2020

(51) Int. Cl. A61H 3/00; F01K 27/00

(52) U.S. Cl. CPC A61H 3/00; F01K 27/00; H02N 2/18; A61H 2201/1238; A61H 2201/1207; A61H 2201/1253

(57) ABSTRACT

This invention relates to methods, apparatuses, systems for boosting and stimulating the motion of weaker body parts of a person or animal by harvesting the power or strength of stronger body parts. It describes mechanisms for harvesting, storage and release of energy from one part of the body to another part of the body. A preferred embodiment of the present invention describes harvesting through mechanical means, storage through mechanical means and release through mechanical means to help harness energy from one strong part of the body to boost the muscular power of a weaker part of the body.

### CROSS-REFERENCE TO RELATED APPLICATIONS

This patent claims benefit of provisional patent application No. 62/886,964 filed on Aug. 15, 2019

### BACKGROUND OF THE INVENTION

### Field of the Invention

This invention is directed to methods, apparatuses, systems for boosting and stimulating the motion of weaker body parts of a person or animal by harvesting the power or strength of stronger body parts.

### Description of the Related Art

Because of age, disease or accidents caused neural and physical injuries, a substantial proportion of the over one billion people worldwide with disabilities face situations in which their ability to effectively and efficiently ambulate is limited by limited strength in one part of the body. A standard approach in this instance has been to provide an external source of energy to help compensate for lost limb strength and facilitate ambulation. Such is for instance the case in the emerging field of medical exoskeletons and other complex rehabilitation technologies, including electric wheelchairs. Such solutions, by failing to provide exercise to those weaker parts badly in need of them lack meaningful rehabilitation benefits, and lead to accelerated physical decline. Furthermore, by relying on an external source of power, these lead to costly, bulky, and less environmentally friendly solutions. The present invention discloses another approach, taking advantage of the observation that human beings tend to compensate for a deficiency, to help harness energy within the body itself where it is in excess, to supply it and stimulate the areas of the body that are weaker.

### SUMMARY

In one embodiment of the present invention, energy is mechanically harvested from the motion of a stronger leg, then stored in an energy storage device such as one or more springs, or batteries, and then released to a weaker leg to boost its extension power.

In another embodiment of the present invention energy is harvest from any part of the body, stored into an energy storage engine such as a spring or a battery, and the released into another part of the body where it is advantageously used.

### BRIEF DESCRIPTION OF THE DRAWINGS

FIG. 1 describes the general architecture of an apparatus enabling energy harvesting, storage and release. FIG. 1a specifies the nature of the components in the case of energy harvested from a stronger left leg to boost a weaker right leg.

FIGS. 2, 2a, and 2b describe the components of the apparatus in the scenario of FIG. 1a, that is strong left leg and a weak right leg.

FIGS. 3, 3a, 3b describe the mechanisms of the energy harvesting phase.

FIGS. 4, 4a and 4b describe the mechanism through which a switch happens before energy can start being released to the weaker right leg, as shown in FIGS. 5 and 5a.

FIG. 6 shows the return to the initial state to restart the loop.

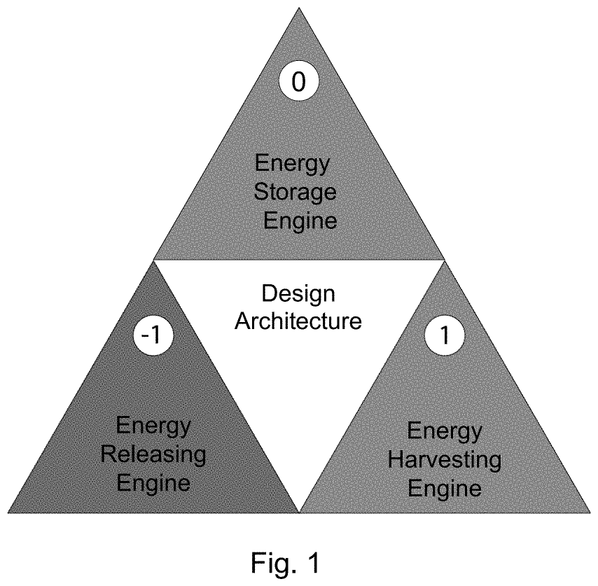

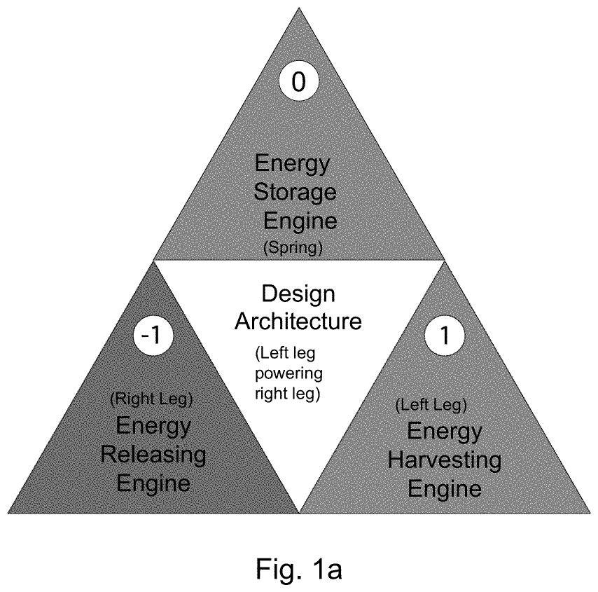

### DETAILED DESCRIPTION

Traditional and widespread methods and devices for alleviating the impairments of the physically impaired population include walking aids such as walkers, crutches, braces, wheelchairs, and other orthotic or orthopedic devices, often in combination with surgical procedures and physical therapy and/or occupational therapy rehabilitation.

In the past decade, research in powered exoskeleton technologies have brought closer to reality the possibility of using these as better enabling alternatives or complementary solutions. However, one of the most vexing problems still facing designers of powered exoskeletons is the difficulty in finding light and dense enough external power sources that can be worn and sustain a full-body powered exoskeleton for more than a few hours. Furthermore cost of such exosuits, when equipped with any meaningful power supply, often have prices in the six figure range, putting them out of reach of the largest number of those who might need them. Exoskeletons or exosuit in this description are used interchangeably, and describes any device around or surrounding the body, whether worn as a piece of clothing or not, and may include an ambulatorily capable standing chair

Purpose

Our purpose is to demonstrate at a conceptual level the mechanics of how to harness from other stronger body parts the power that would feed a substantially self-powered exoskeleton or exosuit as it assists a weakened body part in motion. This approach, more environmentally friendly, sustainable and re-vitalizing would empower the body's weaker parts to self-heal.

Method, Apparatus, System & Mechanism

We accomplish our purpose by studying in detail two examples chosen because they represent a substantial population, in particular individual with polio-like paralytic sequelae. We also chose those examples because they are canonical. This means the solution need to address other cases can be in many instances reduced to a combination of the strategies developed and presented in these two examples. We focus on the situation of a person with asymmetric lower limb strength, where one limb is weaker or partially paralyzed, and the other limb is stronger. In the first example, we study how to self-generate power to aid the person walk more evenly and more efficiently. In the second example, we analyze how to optimally enable the same person to run.

### Example 1: One Strong Leg and One Weak Leg in Normal Ambulation

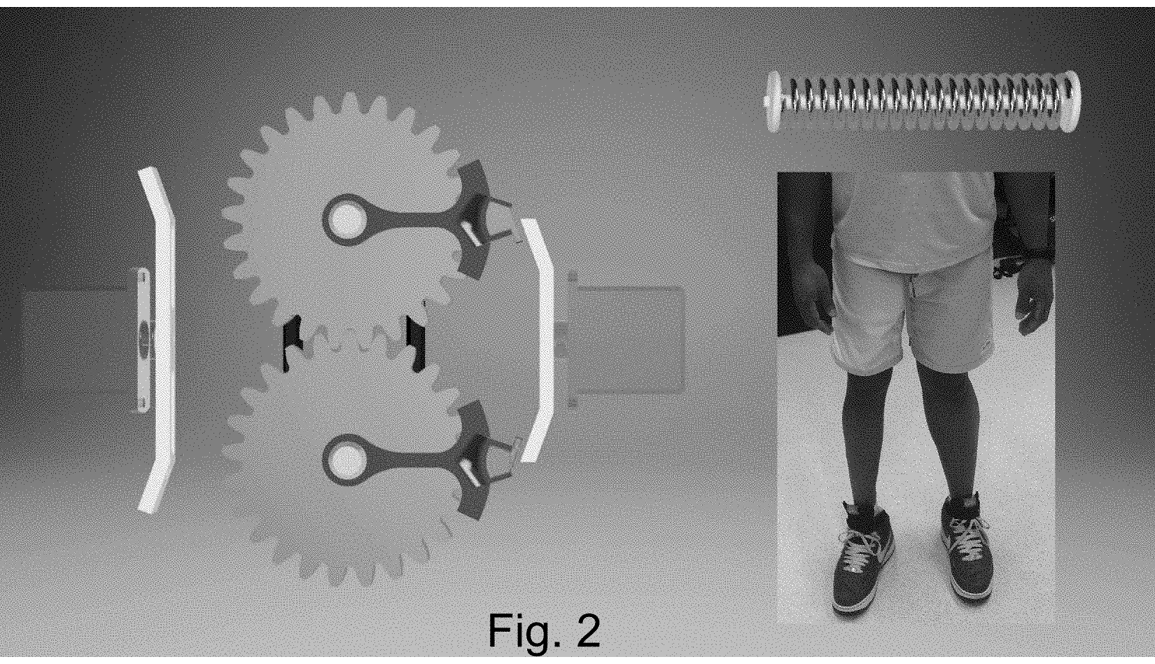

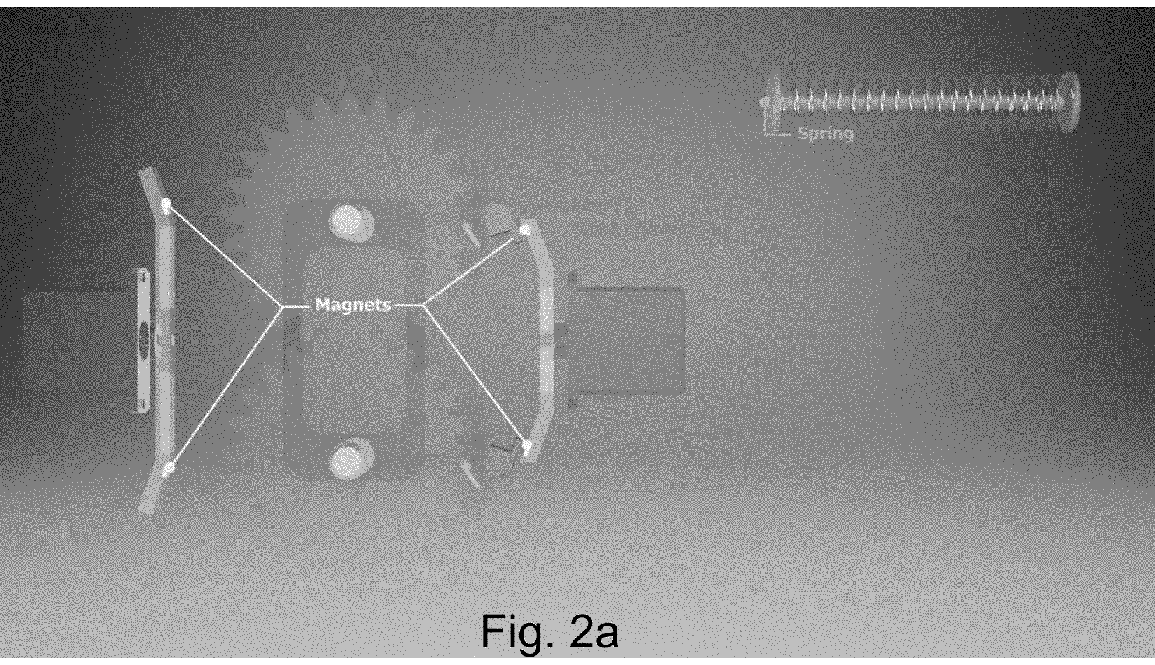

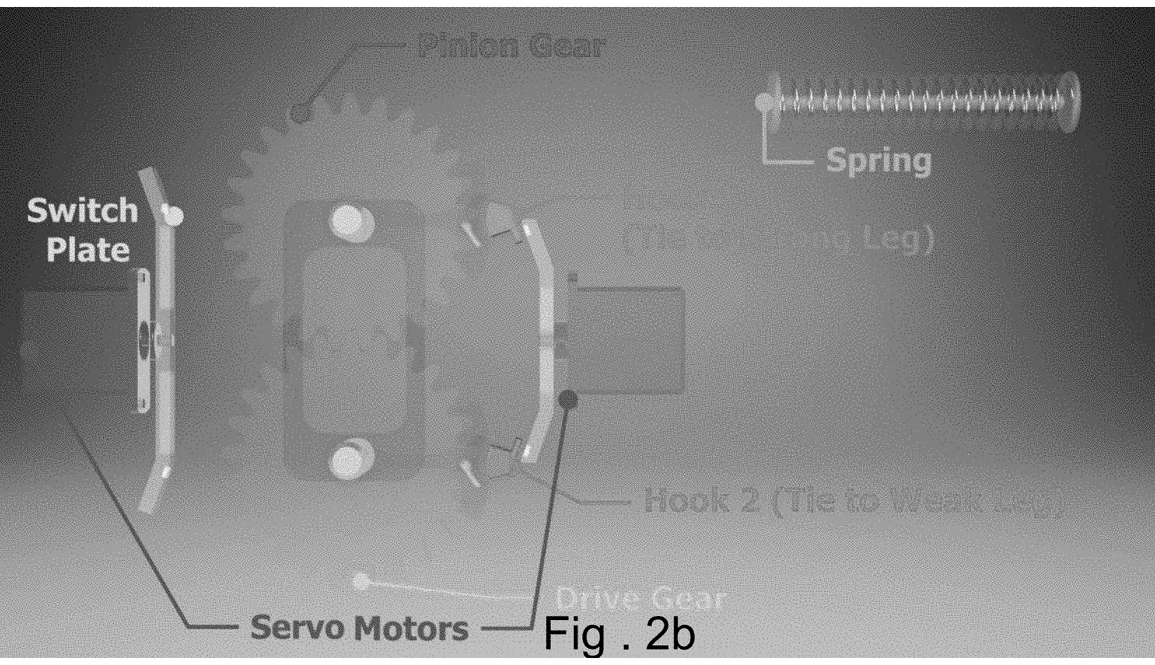

In this example, as shown in FIG. 2, the person has one stronger, more muscular leg and one thinner, atrophied leg, as is the typical case of a paralytic polio survivor_. Our goal is to harness the power of the stronger leg to assist the weaker leg during normal ambulation. Here the left leg is obviously the stronger one and the right leg is the weaker one.

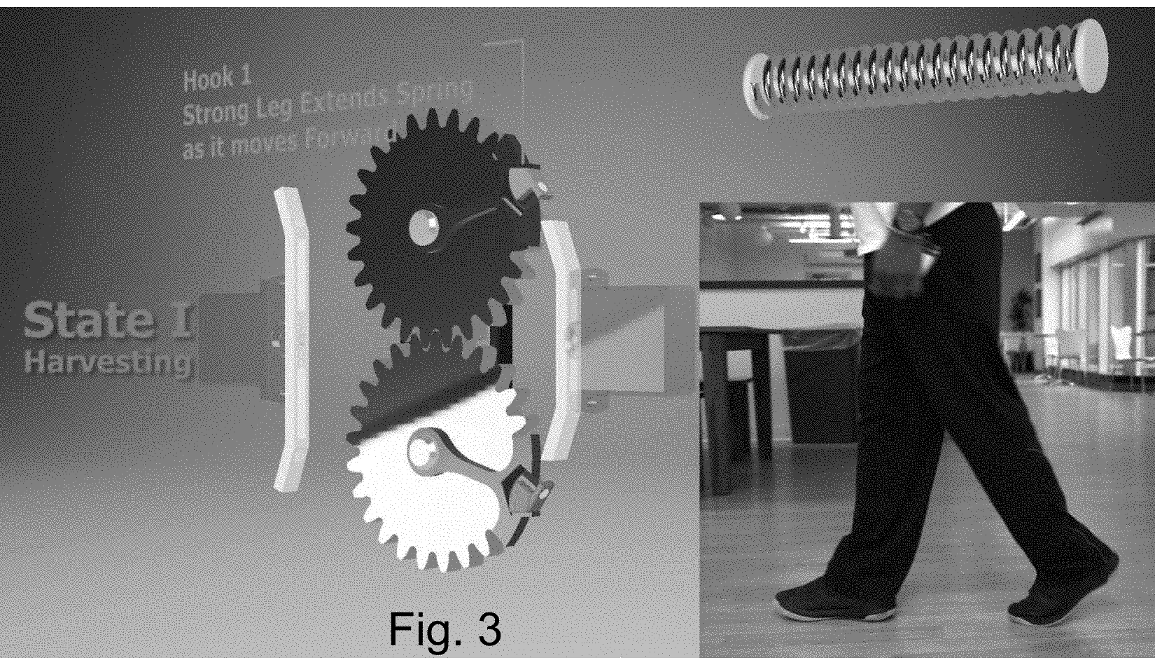

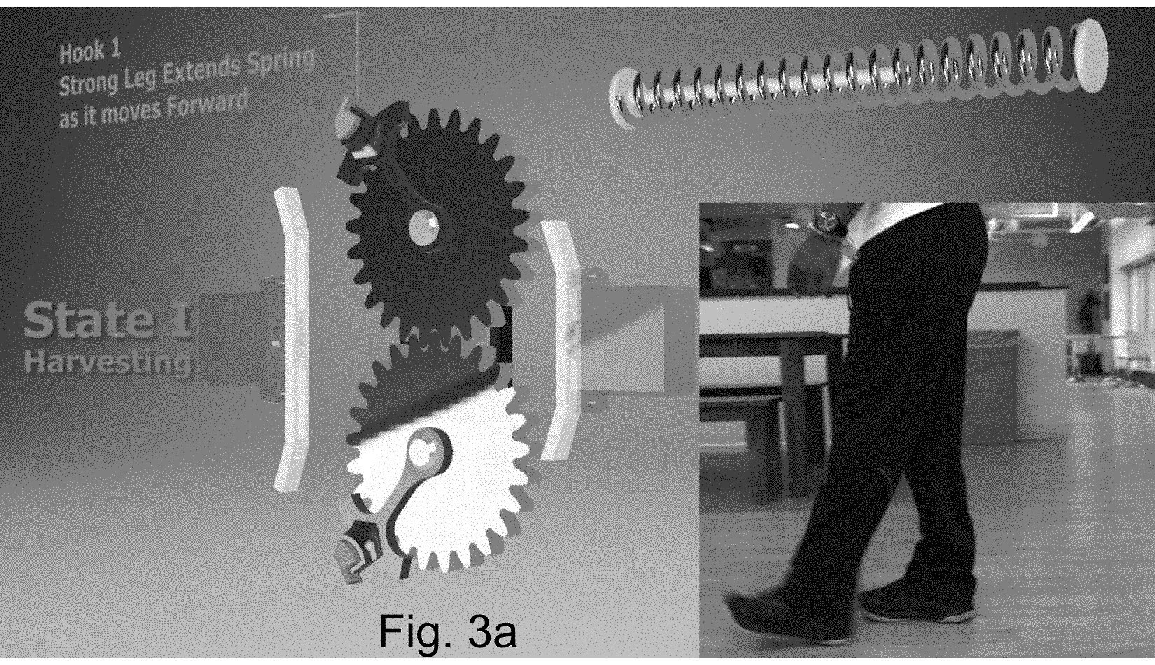

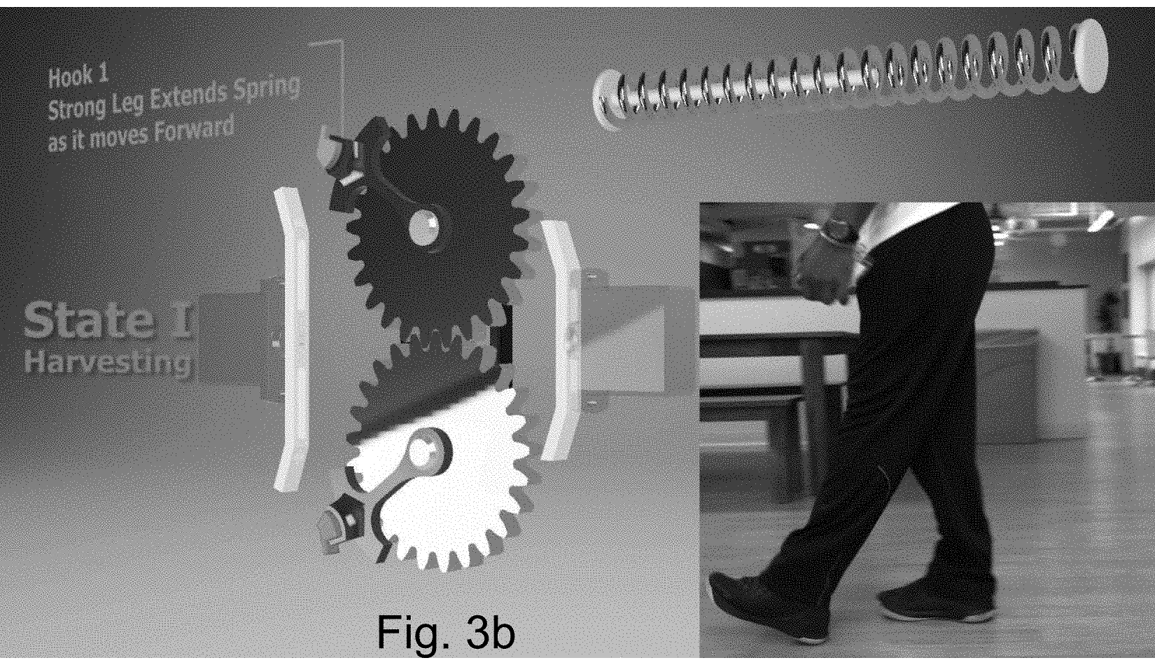

As the person starts to walk, we can readily see (FIGS. 3(a) &3(b).) that as the left leg steps forward, if a spring in the exosuit is attached to its back, resisting its motion by pulling against its extension forward, this will create tension in the spring whose force, if swiftly shifted to pull forward the lagging right leg, will augment the force needed to propel it forward, supplementing the propelling power of the right, weaker quadriceps. Here we can have the spring also helping to lift the right leg at the ankle level FIG. 3(b) or lifting the tip of the right foot forward in case of a dropped foot condition.

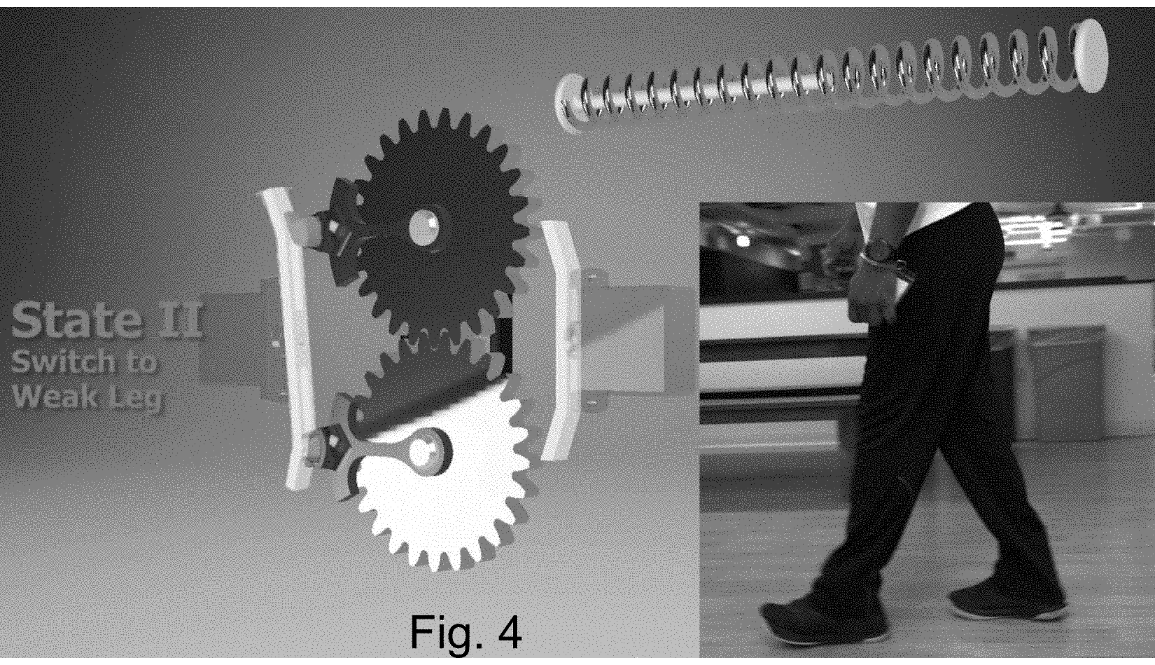

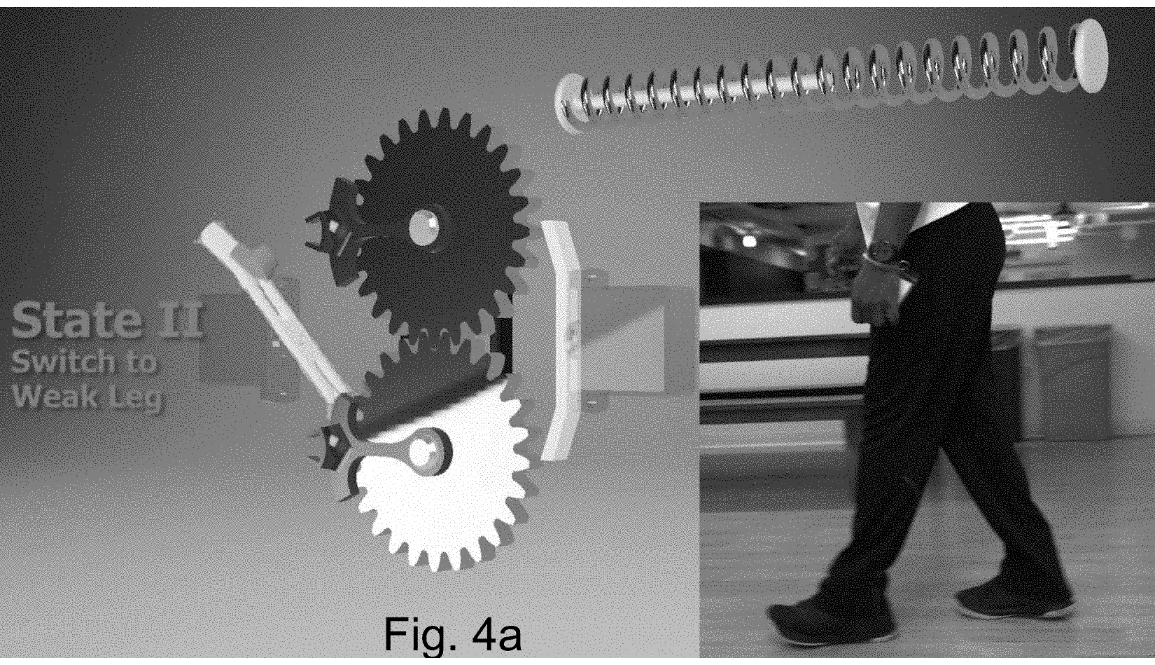

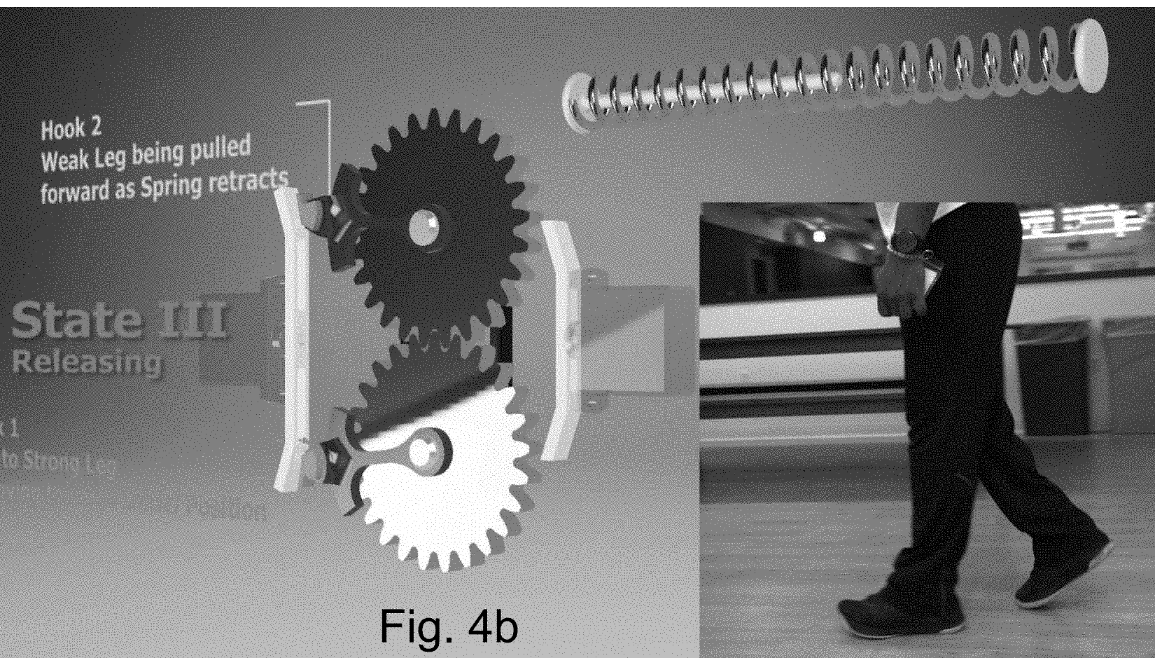

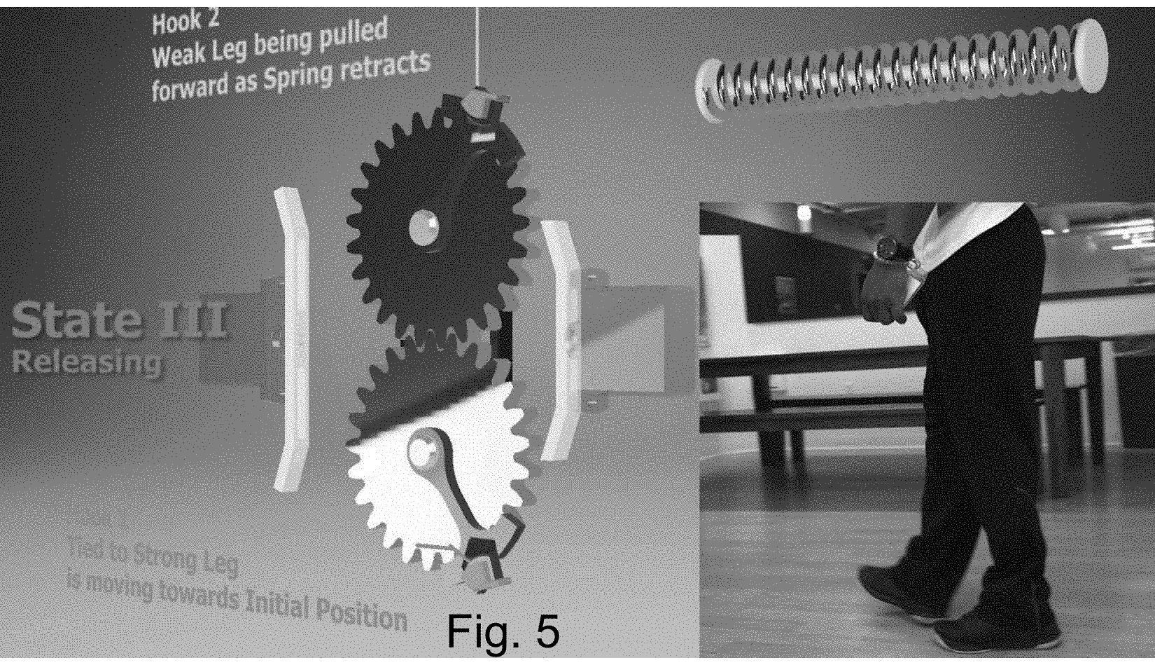

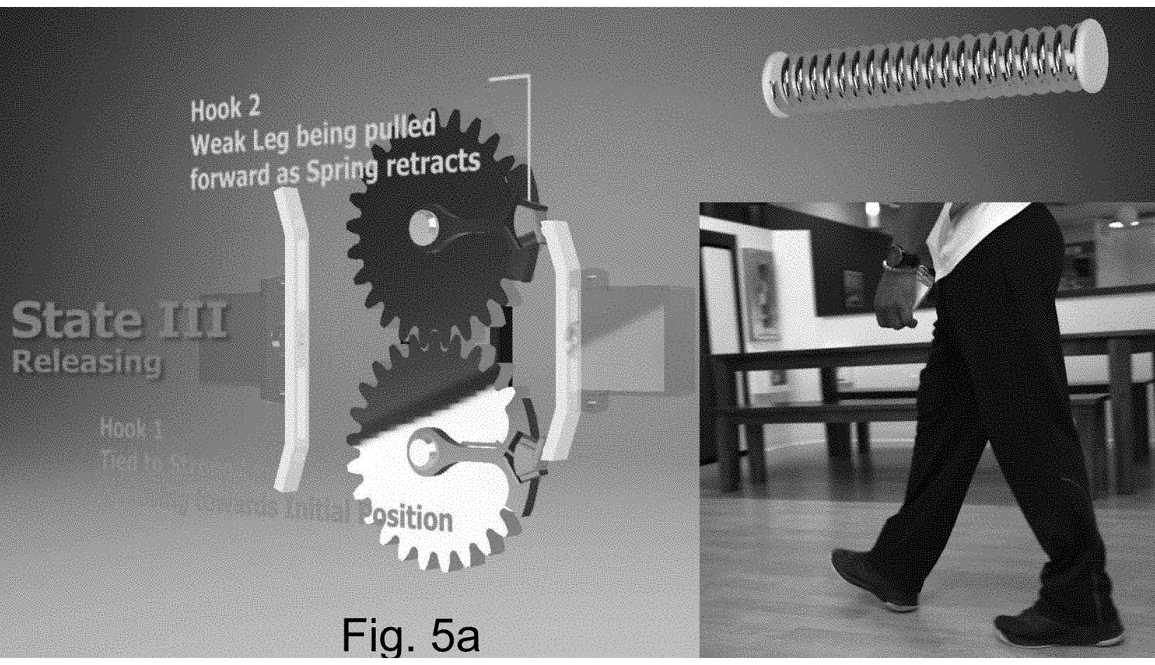

Furthermore, as the left leg now initiates movement forward, a spring in the exosuit tied at its front and linked to a spring tied at the back of the right leg would hasten the back buckling or bending of the right leg at the knee, augmenting the power of both right quads and hamstring. FIG. 4b, FIG. 5, FIG. 5a.

Next, as the left leg extends further forward, the cycle begins again. This thus provides a mechanism through which the left leg transfers muscular power to support a weaker right leg.

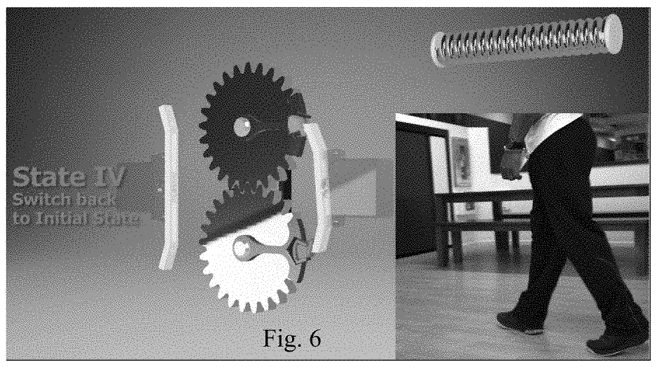

It is therefore easy to see how the mechanical logic explained in FIGS. 2-6, implemented in the mechatronics of a smart exosuit, further refined and calibrated to target individual muscle strengths and weaknesses so as to create perfectly paired abilities on both legs would stimulate rehabilitative, efficient and balanced ambulation, with minimal battery power aid.

### Example 2: One Strong Leg and One Weak Leg while Running

The solution of the previous example can be reasonably anticipated to work perfectly well when the individual is walking at a regular pace where perhaps maximum speed is not of the essence. In the case where the individual is running and wishes to move as fast as possible as shown in FIG. 5, restraining the stronger leg to harness its power means that the stronger leg cannot advance as fast as it otherwise could. This is especially the case, as shown in the picture, where the weaker—right—leg tends to drag.

The question then would become, how could one use the body's other sources of strength to empower the weaker leg to move as fast as the stronger leg at its unencumbered fastest?

One solution in this case would be a MotionRehab exosuit that extends from the lower limbs to the upper body and limbs. As can be since in FIG. 4, as the individual picks up the pace, the arms rotate in sync with the motion of the leg. Therefore, a sustainable solution would seamlessly harness the power of the motion of the arms as they rotate rhythmically with the lower limb.

If the right arm swings forward in unison with the left leg while the right leg is lagging behind, the springs in the exosuit pull back the right arm to lift the right leg forward.

Likewise, if springs are attached to the left arm rotating in phase with right leg, they may further boost its motion forward.

This solution can therefore harness motion from both arms to assist the one weaker limb, helping it to match the strength of the stronger lower limb. The motion rehab exosuit in this case would be worn more like an underclothes diving suit with specialized fibers in the precomputed densities to achieve the desired springing effects at the right places.

### DISCUSSION

The scenarios contemplated in the examples above are generic and their application different situations or more complex impairments leverage similar principles. For instance, if a person with weak legs is attempting to stand up or climb stairs, the strength of their arms can be put to use to assist as shown in the second example. If the physical impairment is of a more complex nature, it is relatively straightforward to see how one can combine the methods of example one and two in an exosuit strength from stronger areas to weaker areas.

### CONCLUSION

In this description, we have used two examples to illustrate the mechanical principles according to which a mostly self-powered exoskeleton or exosuit can be practically designed to suit more general cases of impairment, We can term such built devices MotionRehab because, in addition to facilitating motion, they have a rehabilitative role in that they stimulate the weaker parts of the body to continue to be fully used, thereby strengthening them over time. It is an environmentally more friendly solution, more sustainable, which should reduce the overall cost of the device and facilitate widespread adoption.

I claim:

1. A method of powering an exoskeleton for the purpose of enabling one or more operations of a person or animal with one or more functional limitations, which comprises:
a) harvesting energy from the person or animal's own body rather than an external source of power; and
b) supplying the harvested energy to boost the operation(s) of the areas with the one or more functional limitations.

2. A method as claimed in claim 1, for harvesting energy from the person or animal's own body, wherein the harvesting step comprises:
a) identifying the areas and/or ways of functional limitations and
b) establishing one or more metrics for measuring the limitations.

3. A method as claimed in claim 2, for measuring the limitations, wherein the measuring step comprises:
a) having sensors about the person or animal's body capable of capturing the unaided limitations in a set of one or more numbers in the metrics units; and
b) having another set of one or more benchmark numbers that express the desirable level of functionality, wherein said set of one or more benchmark numbers may be inferred from one or more numbers captured by sensors about the person or animal's body, or from one or more external sources.

4. A method as claimed in claim 1, for supplying the harvested energy to boost the operation(s) of the areas with the one or more functional limitations, wherein the supplying step comprises:
a) identifying one or more possible sources of compensatory energy or power; and
b) selecting among the possible sources, the one or more combination capable of sufficiently and most efficiently supplementing the deficiency(ies) in the areas or ways with functional limitations.
c) operating a mechanism for harvesting the energy from the selected one or more sources and transferring it to supplement the areas or ways with functional limitations, wherein the step of transferring may be asynchronous or synchronous, and include a step of energy storage in a specified medium prior to release.

5. A method as claimed in claim 4, where the specified medium is an electric battery, an extensible elastic material or a compressed air energy storage device.

6. A method as claimed in claim 4, where the process of selecting among the possible sources the one or more combination is performed by one or more specialized processors worn inside the exoskeleton or exosuit.

7. A method as claimed in claim 6, where the mechanism for harvesting energy convert:
a) mechanical energy from one part of the body into mechanical power in another part of the body using springs or elastic materials; or
b) heat produced by the body into electricity using the thermoelectric effect; or
b) heat produced by the body into buoyant uplift force using Archimedes principle through hot air filled expansions of one or more parts of the exosuit; or
c) mechanical stress into electric power using the piezoelectric effect; or
d) solar energy from the sun's beam on the exosuit into electricity using the photo-electric effect.

8. A method as claimed in claim 7, where the functional limitation is a totally or partially paralyzed limb and energy is harvested from one or more stronger limbs.

9. An apparatus for powering an exoskeleton or exosuit worn to facilitate one or more operations of a person or animal with one or more functional limitations, which comprises:
a) a soft tissue underpart or undersuit;
b) a processor;
c) sensors.
